(19) United States
(12) Patent Application Publication
(10) Pub. No.: US 2023/0057606 A1
(43) Pub. Date: Feb. 23, 2023

(54) NEGATIVE ELECTRODE FOR NONAQUEOUS ELECTROLYTE SECONDARY BATTERIES, NONAQUEOUS ELECTROLYTE SECONDARY BATTERY, AND METHOD FOR PRODUCING NEGATIVE ELECTRODE FOR NONAQUEOUS ELECTROLYTE SECONDARY BATTERIES

(71) Applicant: Panasonic Intellectual Property Management Co., Ltd., Osaka-shi, Osaka (JP)

(72) Inventors: Yohei Uchiyama, Hyogo Ken (JP); Keita Okazaki, Osaka Fu (JP)

(73) Assignee: Panasonic Intellectual Property Management Co., Ltd., Osaka-shi, Osaka (JP)

(21) Appl. No.: 17/794,359

(22) PCT Filed: Jan. 26, 2021
(86) PCT No.: PCT/JP2021/002526

§ 371 Date: Jul. 21, 2022

(30) Foreign Application Priority Data
Jan. 31, 2020 (JP) 2020-015901

(51) Int. Cl. H01M 4/1395; H01M 10/0525; H01M 4/62

(52) U.S. Cl. CPC H01M 4/1395; H01M 10/0525; H01M 4/621; H01M 2004/027

(57) ABSTRACT

A negative electrode for a non-aqueous electrolyte secondary battery includes a negative electrode current collector, and a negative electrode mixture layer supported on the negative electrode current collector. The negative electrode mixture layer includes a negative electrode active material capable of electrochemically absorbing and releasing lithium ions, a binder, and a conductive agent. The negative electrode active material includes flaky silicon particles, and the binder includes a silicate.

### TECHNICAL FIELD

The present disclosure relates to a negative electrode for a non-aqueous electrolyte secondary battery, a non-aqueous electrolyte secondary battery, and a method for producing a negative electrode for a non-aqueous electrolyte secondary battery.

### BACKGROUND ART

A non-aqueous electrolyte secondary battery represented by a lithium ion secondary battery includes a positive electrode, a negative electrode, and a non-aqueous electrolyte. The negative electrode includes a negative electrode current collector, and a negative electrode mixture layer supported on the negative electrode current collector. The negative electrode mixture layer includes a negative electrode active material capable of electrochemically absorbing and releasing lithium ions.

Patent Literature 1 proposes using silicon fine particles formed by pulverizing crystalline silicon, as a negative electrode active material of a lithium ion secondary battery.

### CITATION LIST

### Patent Literature

[PTL 1] International publication WO 2015/189926

### SUMMARY OF INVENTION

With increasing sophistication of electronic devices, non-aqueous electrolyte secondary batteries used for their power source are required to have improved cycle characteristics.

In view of the above, one aspect of the present disclosure relates to a negative electrode for a non-aqueous electrolyte secondary battery, including: a negative electrode current collector; and a negative electrode mixture layer supported on the negative electrode current collector, wherein the negative electrode mixture layer includes a negative electrode active material capable of electrochemically absorbing and releasing lithium ions, a binder, and a conductive agent, the negative electrode active material includes flaky silicon particles, and the binder includes a silicate.

Another aspect of the present disclosure relates to a non-aqueous electrolyte secondary battery, including: a positive electrode; a negative electrode; and a non-aqueous electrolyte, wherein the negative electrode is the above-described negative electrode.

Yet another aspect of the present disclosure relates to a method for producing a negative electrode for a non-aqueous electrolyte secondary battery, the method including: a first step of preparing a first shiny containing an organic dispersion medium, and flaky silicon particles dispersed in the organic dispersion medium, a second step of preparing a second slurry containing a silicate serving as a binder, a conductive agent, and water, a third step of applying the first slurry onto a surface of a negative electrode current collector, to form a first applied film containing the silicon particles, and a fourth step of applying the second slurry onto a surface of the first applied film, to form a second applied film containing the silicate and the conductive agent.

According to the present disclosure, the cycle characteristics of the non-aqueous electrolyte secondary battery can be enhanced.

### BRIEF DESCRIPTION OF DRAWINGS

FIG. 1 A schematic cross-sectional view of a flaky silicon particle.

FIG. 2 A schematic cross-sectional view of an example of a negative electrode for a non-aqueous electrolyte secondary battery according to one embodiment of the present disclosure.

FIG. 3 A schematic expanded cross-sectional view of a portion Y of the negative electrode of FIG. 2.

FIG. 4 A partially cut-away schematic oblique view of a non-aqueous electrolyte secondary battery according to one embodiment of the present disclosure.

### DESCIIPTION OF EMBODIMENTS

[Negative Electrode for a Non-Aqueous Electrolyte Secondary Battery]

A negative electrode for a non-aqueous electrolyte secondary battery according to one embodiment of the present disclosure includes a negative electrode current collector, and a negative electrode mixture layer supported on the negative electrode current collector. The negative electrode mixture layer includes a negative electrode active material capable of electrochemically absorbing and releasing lithium ions, a binder, and an electrically conductive agent. The negative electrode active material includes flaky silicon (Si) particles, and the binder includes a silicate. The “flaky” herein includes scaly and spheroidal shapes.

In a negative electrode mixture layer containing flaky Si particles, a conductive agent, and a binder, by using a silicate as the binder, the cycle characteristics can be significantly improved. Although the details are unclear, the reasons therefor can be presumed as follows.

In the negative electrode mixture layer, a plurality of flaky Si particles are packed so as to be stacked in the thickness direction of the negative electrode mixture layer. That is, the plurality of flaky Si particles are piled up with their thickness directions oriented in the thickness direction of the negative electrode mixture layer. Gaps between the Si particles are distributed along the plane of the negative electrode mixture layer. The aforementioned pile-up form of the flaky Si particles is a result of the formation of an applied film containing Si particles by a doctor blade method or the like or of the compression of the applied film in the process of forming the negative electrode mixture layer. In such a negative electrode mixture layer, the stress generated due to expansion and contraction of the Si particles during charge and discharge can be effectively relaxed, and the isolation of Si particles in the negative electrode mixture layer (esp., at the surface) due to repeated charge and discharge (i.e., expansion and contraction of Si particles) can be suppressed.

On the other hand, silicates have good affinity for Si particles (including a silicon dioxide film on the surface of Si particles), which can ensure stable bonding between the Si particles during charge and discharge cycles. Silicates are easily dissolvable in water. By using a silicate by dissolving it in water when forming a negative electrode mixture layer, the surface of fine Si particles can be easily covered with the silicate. Alternatively, by forming a film of Si particles (a film in which flaky Si particles are piled up in the thickness direction) first, and then, using a silicate by dissolving it in water, small gaps between the Si particles in the film can be filled with the silicate. When the binder is CMC, the CMC has a large molecular size and swells when it contains water, and can hardly enter the gaps in the film. Furthermore, silicates have favorable lithium ion conductivity. Even when the surface of the Si particles is covered with the silicate to some extent, the absorption and release of lithium ions by the Si particles through the silicate can proceed smoothly. Moreover, the flaky Si particles are covered at their surface with a film of silicon dioxide which is hardly oxidized, and are easily bondable with the silicate. This bond is a chemical bond and can withstand the expansion and contraction of the Si particles.

The action of the flaky Si particles and the action of the silicate as described above are combined synergistically, and the decrease in capacity due to repeated charge and discharge can be significantly suppressed.

(Flaky Si Particles)

The flaky Si particles are preferably nano-level fine particles. The flaky Si particles may have a thickness T of 30 nm or more and 250 nm or less, and a major axis diameter LD of 500 mu or more and 5000 nm or less. When the thickness T is 250 nm or less, the stress tends to be relaxed because the particles are small, and the occurrence of cracks due to expansion and contraction of the Si particles during charge and discharge tends to be suppressed. When the thickness T is 30 mu or more, the strength of the Si particles tends to be secured, and an appropriate specific surface area tends to be obtained. When the specific surface area is excessively large, it may occur that the Si particles and the non-aqueous electrolyte cause excessive side reactions, and lithium remains on the surface of the Si particles, to inhibit the movement of lithium ions to the positive electrode, resulting in a lowered reaction efficiency. When the major axis diameter LD is 500 mu or more, the pulverization time in the wet pulverization process when producing flaky Si particles can be shortened, which is advantageous in terms of production costs and productivity.

In view of suppressing the occurrence of cracks due to expansion and contraction of the Si particles during charge and discharge, the thickness T may be 200 mu or less, and may be 150 nm or less. The major axis diameter LD may be 2000 mu or less, and may 1000 nm or less.

The flaky Si particles may be finer particles having a thickness T of 30 nm or more and 150 nm or less, and a major axis diameter LD of 60 nm or more and 300 nm or less. In this case, due to the fineness of the Si particles, the occurrence of cracks in the Si particles during charge and discharge tends to be suppressed. However, the pulverization time in the wet pulverization process when producing flaky Si particles is prolonged, and the production costs tend to increase.

In view of packing the flaky Si particles so as to be stacked in the thickness direction of the negative electrode mixture layer, a ratio: LD/T of the major axis diameter LD to the thickness T (hereinafter sometimes referred to as an aspect ratio) is preferably 2 or more, and more preferably 3 or more. In view of suppressing the breakage of the Si particles, the aspect ratio is preferably 15 or less. The aspect ratio may be 2 or more and 15 or less, and may be 3 or more and 15 or less. When the aspect ratio is 2 or more and 3 or less, the thickness T may be 30 nm or more and 150 nm or less.

The thickness T and the major axis diameter LD of the flaky Si particles can be determined by the following method.

An image of a cross section of the negative mixture layer in its thickness direction (a cross section perpendicular to the principal surface of the negative electrode current collector) is obtained using a scanning electron microscope (SEM), to confirm that the Si particles are flaky and that the flaky Si particles are packed so as to be stacked in the thickness direction of the negative electrode mixture layer. When it is difficult to identify the Si particles, an elemental analysis is performed using an energy dispersive X-ray analysis. Next, the thickness T and the major axis diameter LD of the flaky Si particles are determined.

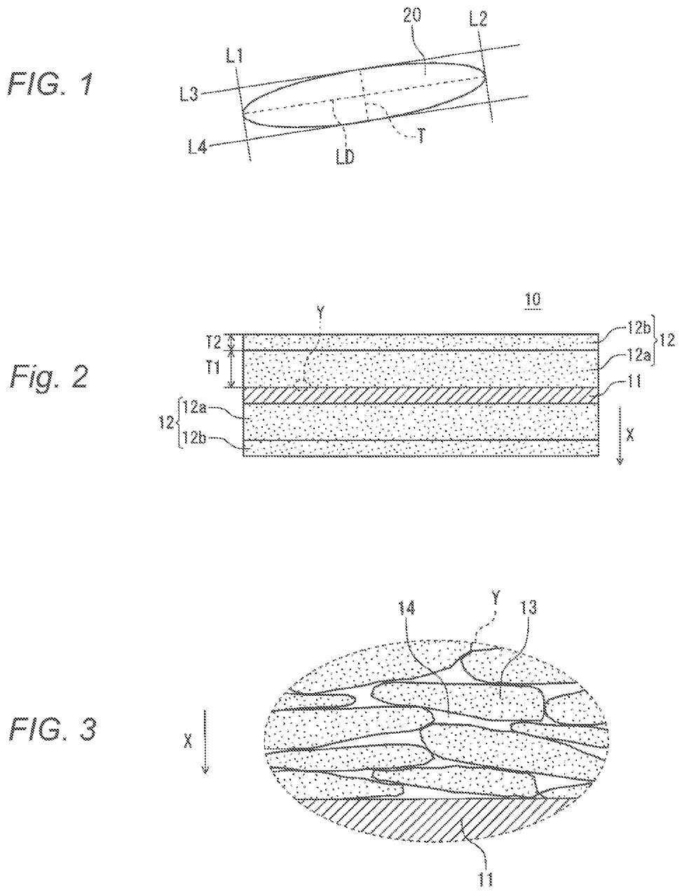

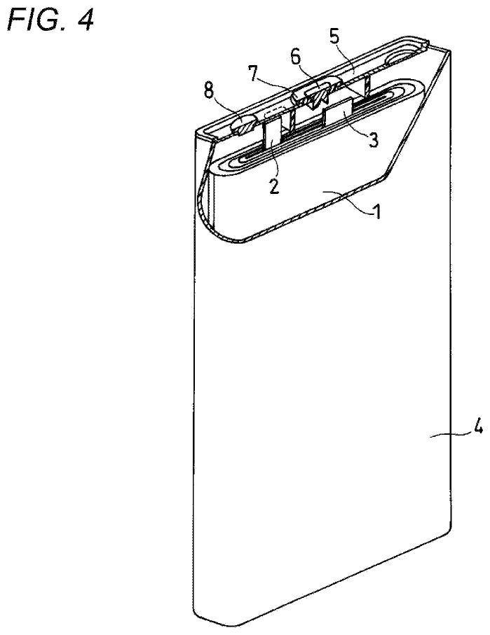

Here, FIG. 1 schematically shows a flaky Si particle observed in a SEM image of a cross section of the negative electrode mixture layer in its thickness direction. The maximum distance between two parallel lines L1 and L2 tangent to the contour of a flaky Si particle 20 in the SEM image is determined as the major axis diameter LD. The distance between two parallel lines L3 and L4 which are orthogonal to the major axis diameter LD and tangent to the contour of the flaky Si particle 20 is determined as the thickness is T.

In the above, any 50 Si particles are selected from the SEM image of the cross section of the negative electrode mixture layer in its thickness direction, and the 50 flaky Si particles are each measured for its major axis diameter LD, to calculate an average value thereof. Furthermore, the 50 flaky Si particles are each measured for its thickness T, to calculate an average value thereof.

In a dark field (DF) image of the silicon particles obtained using a transmission electron microscope (TEM), the ratio of the area of white portions indicating crystals to the area of the silicon particles is preferably 20% or less, more preferably 10% or less. In this case, the proportion of the amorphous portion which is highly reactive with lithium ions is high, and the load characteristics and the cycle characteristics can be easily improved.

The above area ratio can be obtained by the following method.

In the electron beam diffraction mode of a TEM (JEM-F200, available from JEOL Ltd.), an objective aperture of 40 μm in diameter is inserted at the diffraction point, to acquire a dark field image. From the acquired image, the ratio of the area of the white portion(s) indicating crystal moieties in the Si particle to the total area of the Si particle is determined. With respect to 30 or more Si particles, the above area ratio is determined for each particle, to calculate an average value thereof.

The surface of the flaky Si particles is preferably at least partially covered with a silicon dioxide (SiO₂) film. The silicon dioxide film serves to protect the surface of the Si particles, and can suppress the erosion deterioration of the Si particles due to contact with the non-aqueous electrolyte, which can further improve the cycle characteristics. The silicon dioxide film produces lithium silicate and lithium silicide during charge, and the initial capacity tends to increase. Furthermore, the silicon dioxide film has favorable lithium ion conductivity, and the absorption and release of lithium ions by the Si particles can proceed smoothly.

In view of the protection of the Si particles and the smooth absorption and release of lithium ions by the Si particles, the thickness of the silicon dioxide film covering the Si particle surface is preferably, for example, 2 nm or more and 50 nm or less.

The thickness of the silicon dioxide film can be determined by the following method.

A cross-section processing of the negative electrode mixture layer is performed using a focused ion beam (FIB) processing device (e.g., FIB-SEM composite device “NX5000”, available from Hitachi High-Tech Science Co., Ltd.), with the acceleration voltage set to 30 kV. Then, the cross section of the negative electrode mixture layer is observed using a TEM (JEM-F200, available from JEOL Ltd.), with the acceleration voltage set to 200 kV. A mapping analysis by an energy dispersive X-ray (EDX) analysis method is performed, to confirm the silicon dioxide film covering the Si particle surface. For the EDX analysis, for example, an analyzer (JED-2300T) available from JEOL Ltd. is used. From the image of the mapping analysis, the thickness of the silicon dioxide film covering the Si particle surface is measured at any 20 points, to calculate an average value thereof.

The coverage of the Si particle surface with the silicon dioxide film is preferably 3% or more and 30% or less. When the above coverage is 3% or more, the erosion deterioration of the Si particles tends to be suppressed. When the above coverage is 30% or less, the absorption and release of lithium ions by the Si particles tend to proceed smoothly.

The coverage of the Si particle surface with the silicon dioxide film can be determined by the following method.

From the lapping analysis image obtained by the above EDX analysis when confirming the silicon dioxide film, an overall length LA of the contour of the Si particle and a length LP of a portion or portions of the contour of the Si particle where it is covered with silicon dioxide are determined. A ratio LP/LA is calculated to determine the coverage. With respect to any 20 Si particles selected, the coverage is determined for each particle, to calculate an average value thereof.

The Si particles may be constituted entirely of silicon, or may contain a component other than silicon, such as silicon monoxide (SiO). The proportion of the silicon occupying the Si particles is, for example, 50 mass % or more, and may be 100 mass %.

The Si particles may contain at least one component selected from the group consisting of diamond, amorphous carbon, a zirconium oxide, an aluminum oxide, and an yttrium oxide. When containing diamond, the internal bonds within the silicon is strengthened. When containing an oxide, such as an aluminum oxide, the oxide is located at the interface between the silicon particle and the silicon dioxide film, and can strengthen the bond between the two. When containing amorphous carbon, the stress of expansion and contraction of the Si particles tends to be relaxed. The above component may be included inside the Si particles, or partially exposed at the surface of the Si particles. The content of the above component is, for example, 0.5 mass % or more and 5 mass % or less with respect to the total mass of the Si particles containing the above component.

The content of the flaky Si particles in the negative electrode mixture layer may be 20 mass % or more and 94 mass % or less with respect to the total mass of the negative electrode mixture layer. When the content of the flaky Si particles in the negative electrode mixture layer is 20 mass % or more with respect to the total mass of the negative electrode mixture layer, a higher capacity tends to be obtained. When the content of the flaky Si particles in the negative electrode mixture layer is 94 mass % or less with respect to the total mass of the negative electrode mixture layer, the binder and the conductive agent can be sufficiently contained, and the effect of improving the cycle characteristics produced by using the flaky Si particles and the silicate is likely to be obtained.

When the negative electrode mixture layer contains a carbon material as a conductive agent, the content of the flaky Si particles in the negative electrode mixture layer can be determined, for example, by the following method.

Part of the negative electrode mixture layer is collected as a sample, which is then completely dissolved in a heated acid solution (e.g., a mixed acid of hydrofluoric acid and nitric acid), and carbon of a dissolution residue is removed by filtering, to obtain a sample solution. The obtained sample solution is analyzed by an inductively coupled plasma emission spectroscopy (ICP-AES), to determine a total Si amount in the sample. The amount of silicate in the sample obtained by a method as described below is converted into the amount of Si derived from the silicate. The value obtained by subtracting the amount of Si derived from the silicate from the total Si amount is determined as the amount of the Si particles.

(Silicate)

Si particles show a great degree of expansion and contraction during charge and discharge. Containing a silicate in the negative electrode mixture layer can improve the bonding between the Si particles in the negative electrode mixture layer and between the negative electrode mixture layer and the negative electrode current collector, which can suppress the isolation of Si particles and the increase in contact resistance between the negative electrode mixture layer and the negative electrode current collector due to expansion and contraction of the Si particles.

The silicate preferably includes an alkali metal salt, and more preferably includes at least one selected from the group consisting of sodium silicate, potassium silicate, and lithium silicate. The water resistance of the applied film is favorable in the order of Li>K>Na, and the adhesion is favorable in the order of Na>K>Li. In view of the balance between the water resistance and the adhesion, particularly preferred is potassium silicate.

The alkali metal salt of silicic acid can have a composition represented by, for example, M₂O.nSiO₂, where element M is an alkali metal element, and n is a molar ratio of SiO₂ to M₂O. The alkali metal element M preferably contains at least one selected from the group consisting of lithium (Li), sodium (Na), and potassium (K). The sodium silicate is represented by Nₐ₂O.nSiO₂, where n is, for example, 0.5 to 4.0. The potassium silicate is represented by K₂O.nSiO₂, where n is, for example, 1.0 to 5.0. The lithium silicate is represented by Li₂O.NSiO₂, where n is, for example, 2.0 to 10.

In other words, the silicate preferably contains silicon dioxide (SiO₂) and an oxide of an alkali metal element M (M₂O). The silicate may further contain au oxide of a Group 2 element. The oxide of a Group 2 element includes, for example, at least one selected from the group consisting of BeO, MgO, CaO, SrO, and BaO. The silicate may further include another component, such as Al₂O₃, B₂O₃, P₂O₅, and ZᵣO₂.

The content of the silicate in the negative electrode mixture layer may be 3 mass % or more and 20 mass % or less with respect to the total mass of the negative electrode mixture layer. When the content of the silicate in the negative electrode mixture layer is 3 mass % or more with respect to the total mass of the negative electrode mixture layer, the effect of improving the bonding strength produced by using the silicate is likely to be obtained. When the content of the silicate in the negative electrode mixture layer is 20 mass % or less with respect to the total mass of the negative electrode mixture layer, the flaky Si particles can be sufficiently contained in the negative electrode mixture layer, and the effect of improving the cycle characteristics produced by using the silicate and the flaky Si particles is likely to be obtained.

When the negative electrode mixture layer contains a silicate and a carbon material, and the silicate is an alkali metal salt, the content of the silicate in the negative electrode mixture layer can be determined, for example, by the following method.

Part of the negative electrode mixture layer is collected as a sample, which is then completely dissolved in a heated acid solution (e.g., hydrochloric acid), and carbon of a dissolution residue is removed by filtering, to obtain a sample solution. The obtained sample solution is analyzed by an inductively coupled plasma emission spectroscopy (ICP-AES), to determine an amount of the alkali metal element M in the sample. The obtained amount of the alkali metal element M is converted into an amount of the silicate (M₂O.nSi₂O) determined as described later.

The composition of the silicate can be determined, for example, by the following method.

The battery is dismantled, to take out the negative electrode, which is then washed with a non-aqueous solvent, such as ethylene carbonate, and dried. This is followed by processing with a cross section polisher (CP), to obtain a cross section of the negative electrode mixture layer, thereby to prepare a sample. Using a field emission scanning electron microscope (FE-SEM), a reflected electron image of a cross section of the sample is obtained, to observe a particle of the silicate. Using an Auger electron spectroscopic (AES) analyzer, an element analysis is performed on a certain region at the center of the observed silicate particle, to determine the composition of the silicate.

For example, when the silicate is an alkali metal salt, the amounts of the silicon and the alkali metal element M are determined. Assuming that the alkali metal element M entirely forms an oxide M₂O, the amount of M obtained by the above analysis is converted into an amount of M₂O. Assuming that the Si entirely forms SiO₂, the amount of Si obtained by the above analysis is converted into an amount of SiO₂. Based on the amounts of M₂O and SiO₂ obtained as above, the value n in M₂O.nSi₂O is determined. With respect to 10 silicate particles observed, a similar analysis is performed, to calculate an average of the values of n.

(Conductive Agent)

Si particles are poor in electrical conductivity, as compared to the carbon material as described later. By containing a conductive agent in the negative electrode mixture layer, the conductivity between the Si particles in the negative electrode mixture layer and between the negative electrode mixture layer and the negative electrode current collector can be improved. The conductive network between the Si particles is maintained during repeated charge and discharge, and the isolation of Si particles due to their expansion and contraction can be suppressed.

The conductive agent is preferably a carbon material having electrical conductivity. It may be a carbon material capable of electrochemically absorbing and releasing lithium ions. Examples of such a carbon material include graphite, graphitizable carbon (soft carbon), and non-graphitizable carbon (hard carbon). Graphite means a material having a graphite-like crystal structure, examples of which include natural graphite, artificial graphite, expanded graphite, and graphitized Mesophase carbon particles.

Among the above, graphite is preferable, and scaly graphite is more preferable, because charge and discharge are possible, and due to their shapes similar to the flaky silicon particles, the conductive contacts tend to be maintained. Graphite has high electrical conductivity and is excellent in stability during charge and discharge. In addition, graphite has a smaller irreversible capacity than that of the flaky Si particles, and, exhibits smaller changes in volume when they expand and contract.

Other examples of the carbon material having electrical conductivity include carbons, such as acetylene black and Ketjen black, and carbon fibers, such as carbon nanotubes.

The content of the conductive agent in the negative electrode mixture layer may be 3 mass % or more and 60 mass % or less with respect to the total mass of the negative electrode mixture layer. When the content of the conductive agent in the negative electrode mixture layer is 3 mass % or more with respect to the total mass of the negative electrode mixture layer, the effect of improving the conductivity produced by using the conductive agent is likely to be obtained. When the content of the conductive agent in the negative electrode mixture layer is 60 mass % or less with respect to the total mass of the negative electrode mixture layer, the flaky Si particles and the silicate can be contained sufficiently in the negative electrode mixture layer, and the effect of improving the cycle characteristics produced by using the flaky Si particles and the silicate is likely to be obtained.

When the conductive agent is a carbon material, the content of the conductive agent in the negative electrode mixture layer can be determined by, for example, the following method.

Part of the negative electrode mixture layer is collected as a sample, which is then dissolved in an acid, such as hydrochloric acid, and thereafter, filtered through a membrane filter of 0.5 μm or less. The filtrate is dried at 100° C. for 1 hour or more. The mass of the dry product is measured, and then, the carbon content is measured with a combustion-type carbon concentration analyzer (non-dispersive infrared absorption method).

FIG. 2 is a schematic cross-sectional view of an example of a negative electrode for a non-aqueous electrolyte secondary battery according to one embodiment of the present disclosure. A direction X in FIG. 2 indicates the thickness direction (direction perpendicular to the principal surface of the negative electrode current collector 11) of the negative electrode mixture layer 12 (first and second mixture layers 12a and 12b).

A negative electrode 10 includes a negative electrode current collector 11 and a negative electrode mixture layer 12 supported on both sides of the negative electrode current collector 11. As shown in FIG. 2, the negative electrode mixture layer 12 may include a first mixture layer 12a disposed on a surface of the negative electrode current collector 11 and a second mixture layer 12b covering the surface of the first mixture layer 12a. The first mixture layer 12a contains flaky Si particles. The second mixture layer 12b contains a binder and a conductive agent. The second mixture layer 12b is a layer that does not contain flaky Si particles. The first mixture layer 12a preferably further contains a binder and a conductive agent. In FIG. 2, the negative electrode mixture layer 12 is formed on both sides of the negative electrode current collector 11, but this is not a limitation, and the negative electrode mixture layer may be formed on one side of the negative electrode current collector.

FIG. 3 is an enlarged cross-sectional view of a portion Y of the negative electrode 10 of FIG. 2. The portion Y shows part of the first mixture layer and part of the negative electrode current collector. A direction X in FIG. 3 indicates the thickness direction of the first mixture layer 12a of FIG. 2. In the first mixture layer 12a, a plurality of flaky Si particles 13 are packed so as to be stacked in the direction X. The thickness direction of the flaky Si particles 13 is oriented in the direction X. Small gaps 14 between the Si particles 13 are likely to be formed along the plane of the negative electrode mixture layer 12 (first mixture layer 12a). Preferably, a silicate, or a silicate and a conductive agent are present in the gaps 14.

As the Si particles expand and contract during charge and discharge, gaps tend to be formed between the Si particles especially at the surface of the negative electrode mixture layer, and the Si particles and the non-aqueous electrolyte tend to come in contact with each other. By covering the first mixture layer with the second mixture layer, the side reaction caused by the contact between the Si particles and the non-aqueous electrolyte can be suppressed, and the erosion deterioration of the Si particles due to the excessive progress of a film formation on the Si particle surface can be suppressed.

The silicate and the conductive agent in the second mixture layer have favorable lithium ion conductivity and electron conductivity. Therefore, even when the first mixture layer is covered with the second mixture layer to some extent, the absorption and release of lithium ions by the Si particles can proceed smoothly. The second mixture layer covers the surface of the first mixture layer to such an extent that the surface of the first mixture layer and the non-aqueous electrolyte are unlikely to come in contact with each other, and may have a thickness which is sufficiently smaller than that of the first mixture layer.

The thickness T1 of the first mixture layer 12a is, for example, 1 μm or more and 100 μm or less. The thickness T2 of the second mixture layer 12b is, for example, 0.1 μm or more and 5 μm or less.

The thickness T1 of the first mixture layer 12a and the thickness T2 of the second mixture layer 12b can be obtained, for example, by the following method.

A cross section of the negative electrode mixture layer in its thickness direction (a cross section perpendicular to the principal surface of the negative electrode current collector) is observed with a SEM, and an element mapping is performed by energy dispersive X-ray (EDX) analysis, to obtain a Si element distribution. The thickness of a region where the Si element is much distributed is measured at any 10 points, to calculate an average value thereof as a thickness T1 of the first mixture layer. The thickness of a region where the Si element is less distributed is measured at any 10 points, to calculate an average value thereof as a thickness T2 of the second mixture layer.

[Method of Producing Negative Electrode for Non-Aqueous Electrolyte Secondary Battery]

A method for producing a negative electrode for a non-aqueous electrolyte secondary battery according to one embodiment of the present disclosure includes a first step of preparing a first slurry, a second step of preparing a second shiny, a third step of forming a first applied film using the first slurry, and a fourth step of forming a second applied film using the second slurry The first shiny contains an organic dispersion medium and flaky Si particles dispersed in the organic dispersion medium. The second slurry contains a silicate serving as a binder, a conductive agent, and water. In the third step, the first slurry is applied onto a surface of the negative electrode current collector, thereby to form a first applied film containing flaky Si particles. In the fourth step, the second slurry is applied onto the surface of the first applied film, thereby to form a second applied film containing a silicate and a conductive agent.

(First Step)

In the first slurry, in which Si particles are dispersed in the organic dispersion medium, the Si particles are unlikely to come in contact with air. As the organic dispersion medium, alcohols such as methanol, ethanol and isopropyl alcohol, n-hexane, acetone, and the like are used.

In the first step, the first slurry is prepared preferably by dispersing a raw material silicon in an organic dispersion medium, followed by wet pulverization. For the wet pulverization, a pulverizer, such as a bead mill or a ball mill, is used. For example, a raw material silicon and an organic dispersion medium are put into a pot, and after a plurality of beads or balls are put into the pot and the lid is closed, the pot is rotated to perform pulverization. For the pot, for example, a cylindrical container made of stainless steel is used. The beads or balls may be made of, for example, tungsten carbide, stainless steel, alumina, or zirconia.

A dispersion liquid of the flaky Si particles obtained by wet pulverization can be applied as it is onto a negative electrode current collector, thereby to form a film containing the flaky Si particles. It is therefore unnecessary to include a step of drying the Si particles to remove the dispersion medium, or washing the Si particles, which is advantageous in terms of production costs and productivity. Until the Si particles are packed in the negative electrode current collector, the Si particles are unlikely to come in contact with air, and the quality of the Si particles tend to be maintained.

The size and aspect ratio of the flaky Si particles can be adjusted, for example, by adjusting the conditions, such as the size and the number of beads or balls, the rotation speed of the pot, and the crushing time. The above wet pulverization may be carried out in an inert atmosphere.

During the above wet pulverization, a silicon dioxide film can be moderately formed on the surface of the flaky Si particles. The silicon dioxide film has favorable lithium ion conductivity and can be utilized as it is, without being removed, as a protective film for the Si particles. It is therefore unnecessary to include a step of forming a carbon coating or a step of removing the oxide film, which is advantageous in terms of production costs and productivity.

As the raw material silicon, for example, silicon particles obtained by pulverizing high-purity silicon ingots as used for solar cells and semiconductors into powder with a jet mill or the like can be used. Other than this, for example, silicon cutting chips (powdery chips) to be discarded in a production process of silicon wafers for use in solar cells and semiconductor devices can be used. In this case, it is advantageous in terms of costs. Silicon cutting chips are generated during the cutting process of crystalline silicon ingots. A fixed abrasive grain wire (e.g., diamond wire) is used for cutting. When cutting chips are used, the cutting chips themselves are flat and easily become amorphous silicon after being pulverized with a bead mill or the like, which is likely to contribute to the improvement in characteristics. Spherical silicon particles may be used as the raw material silicon.

The silicon cutting chips may be used as they are without washing (removing the components other than Si having attached in the ingot cutting process). Depending on the components other than Si contained in the silicon cutting chips, the cycle characteristics may be improved in some case. For example, carbon present on the surface of silicon particles can relax the expansion and contraction of the silicon particles and improve the cycle characteristics.

(Second Step)

In the second step, water is added to a silicate and a conductive agent, followed by stirring, to obtain a second slurry. It is preferable to use an alkali metal salt of silicic acid as the silicate, and graphite as the conductive agent. In the second slurry, the silicate is dissolved in water. This allows the surface of the particles of the hydrophilic active material or the conductive agent to be covered with the silicate, and allows the silicate to easily enter the gaps within the first applied film. With the second slung, excellent bonding properties tend to be obtained stably in the whole negative electrode.

(Third Step)

In the third step, the first slurry is applied onto a surface of a negative electrode current collector, thereby to form a first applied film containing flaky Si particles.

For the application of the first shiny, for example, a coater, such as a bar coater, a blade coater, a roll coater, a comma coater, a die coater, and a lip coater, is used. With the above-exemplified coater, the flaky Si particles can be easily packed on the negative electrode current collector, such that the Si particles are stacked in the thickness direction of the first applied film. In addition, it is easy to control the thickness of the first applied film.

(Fourth Step)

In the fourth step, the second shiny is applied onto the first applied film, thereby to form a second applied film containing a silicate and a conductive agent. In the fourth step, part of the second slurry (silicate and conductive agent) may be contained in the first applied film. That is, part of the second shiny may be filled in the space between the Si panicles in the first applied film. In the fourth step, most of the second shiny (silicate and conductive agent) may be filled in the space between the Si particles in the first applied film, so that the second applied film is thinly formed. When the first applied film repels the second slurry, and the second slurry is difficult to apply thereto, a surfactant may be added.

For the application of the second slurry, for example, a coater, such as a bar coater, a blade coater, a roll coater, a comma coater, a die coater, and a lip coater, is used. With the above-exemplified coater, part of the second slurry can be easily filled in the space between the Si particles in the first mixture layer.

In view of preventing the first applied film (Si particles) from coming in contact with water, the drying of the second applied film is preferably performed immediately after applying the second slurry.

After applying the first slurry, the first applied film is dried. After applying the second slurry, the second applied film is dried. The dry first and second applied films may be compressed (rolled), if necessary. The drying of the first applied film may be performed before the application of the second shiny, or may be performed after the application of the second slurry, together with the drying of the second applied film. When the drying of the first applied film is performed before the application of the second slurry, part of the second shiny can be easily filled in the space between the Si particles in the first applied film when applying the second slimy.

By the above drying of the first applied film and the second applied film, or compression after drying, a first mixture layer and a second mixture layer are fonned. The first mixture layer is formed of the first slurry, or may be formed of the first slurry and the second slurry. That is, the first mixture layer is a layer containing Si particles, and may further contain a silicate and a conductive agent. The second mixture layer is formed of the second shiny, which is a layer that does not contain Si particles, and contains a silicate and a conductive agent.

[Non-Aqueous Electrolyte Secondary Battery]

A non-aqueous electrolyte secondary battery according to an embodiment of the present disclosure includes a positive electrode, a negative electrode, and a non-aqueous electrolyte, and the negative electrode includes the above-described negative electrode mixture layer.

[Negative Electrode]

The negative electrode includes a negative electrode current collector, and a negative electrode mixture layer supported on a surface of a negative electrode current collector. The negative electrode mixture layer may be formed by preparing a negative electrode slurry containing a negative electrode active material, a binder, a conductive agent, and a dispersion medium, and applying the negative electrode shiny onto a surface of a negative electrode current collector, followed by drying. The dry applied film may be compressed, if necessary. The above-described method for producing a negative electrode may be used to form a negative electrode mixture layer including the first mixture layer and the second mixture layer. The negative electrode mixture layer may be formed on one surface or both surfaces of the negative electrode current collector.

(Negative Electrode Active Material) The negative electrode active material contains at least flaky Si particles, and may further contain another material other than the flaky Si particles. The negative electrode active material other than the flaky Si particles is, for example, a carbon material capable of electrochemically absorbing and releasing lithium ions. In view of achieving a higher capacity, the proportion of the flaky Si particles occupying the negative electrode active material is preferably 80 mass % or more, more preferably 100 mass %.

The binder contains at least a silicate, and may further contain another material other than the silicate. In view of achieving improved cycle characteristics, the proportion of the silicate occupying the binder is preferably 80 mass % by mass or more, more preferably 100 mass %.

The binder other than the silicate may be a resin material, examples of which include: fluorocarbon resin, such as polytetrafluoroethylene and polyvinylidene fluoride (PVDF); polyolefin resin, such as polyethylene and polypropylene; polyimide resin, such as aramid resin: polyimide resin, such as polyimide and polyamide-imide; an acrylic resin, such as polyacrylic acid, polymethyl acrylate, and ethylene-acrylic acid copolymer; vinyl resin, such as polyvinyl acetate; and a rubbery material, such as styrene-butadiene copolymer rubber (SBR).

Also, as the binder other than the silicate, for example, carboxymethyl cellulose (CMC) and a modified product thereof (including a salt, such as Na salt), a cellulose derivative (e.g., cellulose ether), such as methyl cellulose; a saponificated product of a polymer having a vinyl acetate unit, such as polyvinyl alcohol, and the like may be used. These may be used singly or in combination of two or more kinds.

The conductive agent preferably includes the above carbon material, and more preferably includes graphite. In view of improving the cycle characteristics, the proportion of the carbon material occupying the conductive agent is preferably 80 mass % or more, more preferably 100 mass %. As the conductive agent, other than the above carbon material, powder or fibers of metal, such as aluminum, may be used. The conductive agent may be used singly or in combination of two or more kinds.

As the dispersion medium of the negative electrode shiny, for example, water, an alcohol, such as ethanol, an ether, such as tetrahydrofuran, an amide such as dimethylformamide, and N-methyl-2-pyrrolidone (NMP) can be used. The dispersion medium may be used singly or in combination of two or more kinds. An alcohol has chemically active oxygen, which oxidizes silicon moderately, and can contribute to the improvement in characteristics. On the other hand, n-hexane does not contain oxygen, and contributes little to the improvement in characteristics.

(Negative Electrode Current Collector)

Examples of the negative electrode current collector include a non-porous electrically conductive substrate (e.g., metal foil) and a porous electrically conductive substrate (e.g., mesh, net, punched sheet). The negative electrode current collector may be made of, for example, stainless steel, nickel, a nickel alloy, copper, or a copper alloy. The thickness of the negative electrode current collector is not limited, but is preferably 1 to 50 μm, more preferably 5 to 20 μm, in view of balancing between maintaining the strength and reducing the weight of the negative electrode.

The metal foil used for the negative electrode current collector preferably has a surface roughness (arithmetic mean roughness) Ra of 0.5 μm or more and 5 μm or less. The arithmetic mean roughness Ra is determined in accordance with JIS B 0601 (2013).

When the surface roughness Ra of the metal foil is 0.5 μm or more, favorable adhesion between the negative electrode mixture layer and the metal foil tends be securely maintained during charge and discharge. The detailed reason therefor is unclear, but can be presumed as follows. Since the flaky Si particles are packed so as to be stacked in the thickness direction of the negative electrode mixture layer, the stress generated due to expansion and contraction of the Si particles is greater in the plane direction than in the thickness direction of the negative electrode mixture layer. When the Ra is 0.5 μm or more, in the vicinity of the metal foil, the stress generated in the plane direction of the negative electrode mixture layer due to expansion and contraction of the Si particles tends to be received by the protruding portions on the surface of the metal foil, and the stress applied to the interface between the negative electrode mixture layer and the metal foil tends to be relaxed. On the other hand, when the surface roughness Ra of the metal foil is 5 pin or less, the unevenness produces an anchor effect, leading to an improved adhesion with the negative electrode mixture layer.

[Positive Electrode]

The positive electrode includes, for example, a positive electrode current collector, and a positive electrode mixture layer supported on a surface of the positive electrode current collector. The positive electrode mixture layer can be formed by applying a positive electrode shiny of a positive electrode mixture dispersed in a dispersion medium, onto a surface of the positive electrode current collector, followed by drying. The dry applied film may be rolled, if necessary. The positive electrode mixture layer may be formed on a surface of one side or both sides of the positive electrode current collector. The positive electrode mixture includes, as an essential component, the positive electrode active material, and may include a binder, a conductive agent, and other optional components. The dispersion medium of the positive electrode slurry may be NMP or the like.

The positive electrode active material may be, for example, a composite oxide containing lithium and a transition metal. Examples of the transition metal include Ni, Co, and Mn. Examples of the composite oxide containing lithium and a transition metal include LiₐCoO₂, LiₐNiO₂, LiₐMnO₂, LiₐCo_{b}Ni_{1-b}O₂, LiₐCo_{b}Me_{1-b}O_{c}, LiₐMn₂O₄ LiₐMn_{2-b}Me_{b}O₄, LiMePO₄, and Li₂MePO₄F, where Me is at least one selected from the group consisting of Na, Mg, Sc, Y, Mn, Fe, Co, Ni, Cu, Zn, Al, Cr, Pb, Sb, and B. Here, a=0 to 1.2, b=0 to 0.9, and c=2.0 to 2.3. The value “a” representing the molar ratio of lithium is a value immediately after the production of the active material, and increases and decreases during charge and discharge.

In particular, preferred is a lithium-nickel composite oxide represented by LiₐNi_{b}Me_{1-b}O₂, where Me is at least one selected from the group consisting of Mn, Co, Al, Fe, Ti, Sr, and B, 0<a≤1.2, and 0.3≤b≤1. In view of achieving a higher capacity, b preferably satisfies 0.85≤b≤1. In view of the stability of the crystal structure, more preferred is LiₐNi_{b}Co_{c}Al_{d}O₂ containing Co and Al as elements represented by Me, where 0<a≤1.2, 0.85≤b<1, 0<c<0.15, 0<d≤0.1, and b+c+d=1.

Examples of the binder and the conductive agent are as those exemplified for the negative electrode.

The form and the thickness of the positive electrode current collector may be respectively selected from the forms and the range corresponding to those of the negative electrode current collector. The positive electrode current collector may be made of, for example, stainless steel, aluminum, an aluminum alloy, and titanium.

[Non-Aqueous Electrolyte]

The non-aqueous electrolyte includes a non-aqueous solvent and a lithium salt dissolved in the non-aqueous solvent. The concentration of the lithium salt in the non-aqueous electrolyte is preferably, for example, 0.5 mol/L or more and 2 mol/L or less. By setting the lithium salt concentration in the above range, a non-aqueous electrolyte having excellent ion conductivity and appropriate viscosity can be obtained. However, the lithium salt concentration is not limited to the above.

As the non-aqueous solvent, for example, a cyclic carbonic acid ester, a chain carbonic acid ester, a cyclic carboxylic acid ester, a chain carboxylic acid ester, and the like can be used. Examples of the cyclic carbonic acid ester include propylene carbonate (PC) and ethylene carbonate (EC). Examples of the chain carbonic acid ester include diethyl carbonate (DEC), ethyl methyl carbonate (EMC), and dimethyl carbonate (DMC).

Examples of the cyclic carboxylic acid ester include γ-butyrolactone (GBL) and γ-valerolactone (GVL). Examples of the chain carboxylic acid ester include methyl formate, ethyl formate, propyl formate, methyl acetate, ethyl acetate, propyl acetate, methyl propionate, ethyl propionate, and propyl propionate. The non-aqueous solvent may be used singly or in combination of two or more kinds.

As the lithium salt, for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, borates, imides, and like can be used. Examples of the borates include lithium bis(1,2-benzenediolate(2-)-O, O′) borate, lithium bis(2,3-naphthalenediolate(2-)-O,O′) borate, lithium bis(2,2′-biphenyldiolate(2-)-O,O′) borate, and lithium bis(5-fluoro-2-olate-1-benzenesulfonate-O,O′) borate. Examples of the imides include lithium bisfluorosulfonyl imide (LiN(FSO₂)₂), lithium bis(trifluoromethanesulfonyl)imide (LiN(CF₃SO₂)₂), lithium trifluoromethanesulfonyl nonafluorobutanesulfonyl imide (LiN(CF₃SO₂)(C₄F₉SO₂)), and lithium bis(pentafluoroethanesulfonyl)imide (LiN(C₂F₅SO₂)₂). The lithium salt may be used singly or in combination of two or more kinds. The concentration of the lithium salt in the non-aqueous electrolyte is, for example, 0.5 mol/L or more and 2 mol/L or less. The lithium salt may be used singly or in combination of two or more kinds.

[Separator]

Usually, it is desirable to interpose a separator between the positive electrode and the negative electrode. The separator is excellent in ion permeability and has moderate mechanical strength and electrically insulating properties. The separator may be, for example, a macroporous thin film, a woven fabric, or a nonwoven fabric. The separator is preferably made of, for example, polyolefin, such as polypropylene or polyethylene.

The non-aqueous electrolyte secondary battery, for example, has a structure in which an electrode group formed by winding the positive electrode and the negative electrode with the separator interposed therebetween is housed in an outer case, together with the non-aqueous electrolyte. The wound-type electrode group may be replaced with a different form of electrode group, for example, a stacked-type electrode group formed by stacking the positive electrode and the negative electrode with the separator interposed therebetween. The non-aqueous electrolyte secondary battery may be in any form, such as cylindrical type, prismatic type, coin type, button type, or laminate type.

The structure of a prismatic non-aqueous electrolyte secondary battery as an example of the non-aqueous electrolyte secondary battery according to the present disclosure will be described below with reference to FIG. 1. FIG. 1 is a schematic partially cut-away oblique view of a non-aqueous electrolyte secondary battery according to one embodiment of the present disclosure.

The battery includes a bottomed prismatic battery case 4, and an electrode group 1 and an electrolyte housed in the battery case 4. The electrode group 1 has a long negative electrode, a long positive electrode, and a separator interposed between the positive electrode and the negative electrode and preventing them from directly contacting with each other. The electrode group 1 is formed by winding the negative electrode, the positive electrode, and the separator around a flat plate-like winding core, and then removing the winding core.

To the negative electrode current collector of the negative electrode, a negative electrode lead 3 is attached at its one end, by means of welding or the like. The negative electrode lead 3 is electrically connected at its other end to a negative electrode terminal 6 disposed at a sealing plate 5. The negative electrode terminal 6 is electrically insulated from the sealing plate 5 by a resin gasket 7. To the positive electrode current collector of the positive electrode, a positive electrode lead 2 is attached at its one end, by means of welding or the like. The positive electrode lead 2 is connected at its other end to the back side of the sealing plate 5 via an insulating plate. That is, the positive electrode lead 2 is electrically connected to the battery case 4 serving as a positive electrode terminal. The insulating plate provides electrical insulation between the electrode group 1 and the sealing plate 5 and between the negative electrode lead 3 and the battery case 4. The periphery of the sealing plate 5 is engaged with the opening end of the battery case 4, and the engaging portion is laser-welded. In this way, the opening of battery case 4 is sealed with the sealing plate 5. An electrolyte injection port provided in the sealing plate 5 is closed with a sealing stopper 8.

### EXAMPLES

The present disclosure will be more specifically described below with reference to Examples and Comparative Examples. It is to be noted, however, that the present invention is not limited to the following Examples.

### Example 1

[Preparation of First Slurry]

A raw material silicon was dispersed in an organic dispersion medium and wet-pulverized, to prepare a first shiny in which flaky Si particles were dispersed in the organic dispersion medium (first step).

The raw material silicon used here was obtained by pulverizing silicon as used in a production process of silicon wafers, with a jet mill. The organic dispersion medium used here was isopropyl alcohol. For wet pulverization, a bead mill (LMZ015, available from Ashizawa Finetech Ltd.) was used. Specifically, 75 g of the raw material silicon and 425 g of the organic dispersion medium were fed into a pot, to which 0.5 kg of zirconia beads (diameter: 0.3 mm) were further added, and with lid closed (packing ratio: 90%), pulverization was performed for 1 hour in an inert atmosphere. The circumferential speed was to 14 m/s, and the flow rate was set to 0.5 L/min. The screen mesh size was 0.1 min.

[Preparation of Second Slurry]

To a binder and a conductive agent, water was added and stirred using a mixer (T.K. HIVIS MIX, available from PRIMIX Corporation), to prepare a second shiny (second step). The binder used here was potassium silicate (K₂O.nSiO₂) powder (n=3). The conductive agent used here was acetylene black (AB) powder (Deuka Black Li100, available from Denka, average particle diameter (D50): 35 nm). The mass ratio of the binder to the conductive agent was 1:1.

[Production of Negative Electrode]

The first slurry was applied onto a surface of a copper foil (thickness: 10 μm) serving as a negative electrode current collector, and the first applied film was dried, and then, the second shiny was applied onto the surface of the first applied film, and the second applied film was dried (third and fourth steps). The dry first and second applied films were compressed. In this way, a first mixture layer containing Si particles and a second mixture layer containing a silicate and a conductive agent (a layer not containing Si particles) were formed in this order on both sides of the copper foil, and a negative electrode was thus obtained. The first mixture layer further contained the silicate and the conductive agent derived from the second slurry. The second slurry was applied in such an amount that the total mass of the silicate and the conductive agent filled on the copper foil per unit area 1 cm² was 2/8 of the mass of the Si particles filled on the copper foil per unit area 1 cm². That is, the content of the Si particles in the negative electrode mixture layer (the total of the first mixture layer and the second mixture layer) was set to 80 mass % with respect to the total mass of the negative electrode mixture layer. The content of the silicate in the negative electrode mixture layer was 10 mass % with respect to the total mass of the negative electrode mixture layer. The content of the AB in the negative electrode mixture layer was 10 mass % with respect to the total mass of the negative electrode mixture layer.

The thickness T1 of the first mixture layer and the thickness T2 of the second mixture layer determined by the already-described method were 20 μm and 1 μm, respectively. A cross section of the negative electrode mixture layer (first mixture layer) was observed with a SEM. The observation showed that fine flaky Si particles were packed so as to be stacked in the thickness direction of the negative electrode mixture layer.

The thickness T of the flaky Si particles determined by the already-described method was 100 nm. The major axis diameter LD of the flaky Si particles determined by the already-described method was 1000 urn. The ratio of (major axis diameter LD/thickness T) was 10. The thickness of the silicon dioxide film on the surface of the flaky Si particles determined by the already-described method was 9 nm.

[Preparation of Positive Electrode]

To a positive electrode mixture, N-methyl-2-pyrrolidone (NMP) was added and stirred using a mixer (T.K. HIVIS MIX, available from PRIMIX Corporation), to prepare a positive electrode slurry. The positive electrode mixture used here was a mixture of a positive electrode active material (LiNi_{0.8}CO_{0.18}Al_{0.02}O₂), acetylene black serving as a conductive agent, and polyvinylidene fluoride serving as a binder (95:2.5:2.5 by mass). Next, the positive electrode slurry was applied onto a surface of an aluminum foil (thickness: 20 μm), and the applied film was dried, and then compressed into a positive electrode mixture layer. The positive electrode mixture layer was formed on both sides of the aluminum foil. A positive electrode was thus produced.

[Preparation of Non-Aqueous Electrolyte]

A non-aqueous electrolyte was prepared by dissolving a lithium salt in a non-aqueous solvent. The non-aqueous solvent used here was a mixed solvent of ethylene carbonate (EC) and dimethyl carbonate (DMC) (3:7 by volume). The lithium salt used here was LiPF₆, and the concentration of LiPF₆ in the non-aqueous electrolyte was set to 1.0 mol/L.

[Fabrication of Non-Aqueous Electrolyte Secondary Battery]

The positive electrode and the negative electrode, with a tab attached to each electrode, were wound spirally with a separator interposed therebetween such that the tab was positioned at the outermost layer, thereby to form an electrode group. The electrode group was inserted in an outer case made of aluminum laminated film, and vacuum-dried at 105° C. for 2 hours, into which the non-aqueous electrolyte was injected. The opening of the outer case was sealed, and a battery Al was thus obtained.

The battery fabricated as above was evaluated as follows.

[Evaluation 1: Initial Charge Capacity]

With respect to each battery, at 25° C., constant-current charge was performed at a current of 1 It (800 mA) until the voltage reached 4.2 V, and then, constant-voltage charge was performed at a voltage of 4.2 V until the current reached 1/20 It (40 mA), to determine an initial charge capacity. The initial charge capacity was expressed as an index, with the initial charge capacity of a battery B1 of Comparative Example 1 taken as 100.

[Evaluation 2: Capacity Retention Ratio at 100th Cycle]

Charge and discharge were repeated under the following conditions.

<Charge>

At 25° C., constant-current charge was performed at a current of 1 It (800 mA) until the voltage reached 4.2 V, and then constant-voltage charge was performed at a voltage of 4.2 V until the current reached 1/20 It (40 mA).

<Discharge>

At 25° C., constant-current discharge was performed at a current of 1 It (800 mA) until the voltage reached 2.75 V.

The rest time between the charge and discharge was set to 10 minutes. The ratio of the discharge capacity at the 100th cycle to the discharge capacity at the 1st cycle was calculated as a capacity retention ratio, and was expressed as an index, with the capacity retention ratio of the battery B1 of Comparative Example 1 taken as 100.

### Example 2

A battery A2 of Example 2 was fabricated and evaluated in the same manner as in the battery A1 of Example 1, except that in the preparation of the first shiny, a powder obtained by washing silicon cutting chips generated in a production process of silicon wafers was used as the raw material silicon. The thickness of the silicon dioxide film on the surface of the flaky Si particles determined by the already-described method was 10 inn.

### Example 3

In the preparation of the first slurry, a powder obtained by washing silicon cutting chips generated in a production process of silicon wafers was used as the raw material silicon. In the preparation of the second slurry, instead of AB, graphite (graphite UP-5α, available from Nippon Graphite Industries, Ltd.) was used as the conductive agent. Except for the above, a battery A3 of Example 3 was fabricated and evaluated in the same manner as in the battery A1 of Example 1. The thickness of the silicon dioxide film on the surface of the flaky Si particles determined by the already-described method was 8 nm.

### Comparative Example

In the preparation of the first slurry, a powder of 10 μm in average particle diameter obtained by pulverizing silicon as used in a production process of silicon wafers with a jet mill was used as the raw material silicon, and n-hexane was used as the organic dispersion medium. The circumferential speed was set to 18 m/s, and the flow rate was set to 0.75 L/min.

In the preparation of the second slurry, water was added to the conductive agent without adding the binder, and stirred using a mixer (T.K. HIVIS MIX, available from PRIMIX Corporation).

Except for the above, a battery B1 of Comparative Example 1 was fabricated and evaluated in the same manner as in the battery A1 of Example 1. The Si particles were almost spherical in shape and had a particle diameter of approximately 30 nm.

### Comparative Example 2

In the preparation of the first slurry, a powder of 10 μm in average particle diameter obtained by pulverizing silicon as used in a production process of silicon wafers with a jet mill was used as the raw material silicon, and n-hexane was used as the organic dispersion medium. The circumferential speed was set to 18 m/s, and the flow rate was set to 0.75 L/min.

Except for the above, a battery B2 of Comparative Example 2 was fabricated and evaluated in the same manner as in the battery A1 of Example 1.

### Comparative Example 3

In the preparation of the first slurry, a powder of 10 μm in average particle diameter obtained by pulverizing silicon as used in a production process of silicon wafers with a jet mill was used as the raw material silicon, and n-hexane was used as the organic dispersion medium.

In the preparation of the second shiny, instead of the potassium silicate, a sodium salt of carboxymethyl cellulose (CMC-Na) and styrene-butadiene rubber (SBR) were used as the binder.

Except for the above, a battery B3 of Comparative Example 3 was fabricated and evaluated in the same manner as in the battery A1 of Example 1.

### Comparative Example 4

In the preparation of the first shiny, a powder of 10 μm in average particle diameter obtained by pulverizing silicon as used in a production process of silicon wafers with a jet mill was used as the raw material silicon, and n-hexane was used as the organic dispersion medium.

In the preparation of the second slurry, instead of the potassium silicate, CMC-Na was used as the binder.

Except for the above, a battery B4 of Comparative Example 4 was fabricated and evaluated in the same manner as in the battery A1 of Example 1.

TABLE 1

| | | Si particles | | | | | | | | | |
|---|---|---|---|---|---|---|---|---|---|---|---|
| | | | | | Proportion of | | | | | | |
| | | | Major | | white portion(s) | | | | | Evaluation | |
| | | | axis | Thickness of | in TEM-DF | | | | | Initial | Capacity |
| | | Thickness | diameter | SiO₂ film on | image of Si | Binder | | Conductive agent | | charge | retention |
| | | T | LD | Si panicles | particle | | Content | | Content | capacity | ratio |
| | Battery | (nm) | (nm) | (nm) | (%) | Kind | (mass %) | Kind | (mass %) | (index) | (index) |
| Ex. 1 | A1 | 100 | 1000 | 9 | 75 | potassium silicate | 10 | AB | 10 | 108 | 125 |
| Ex. 2 | A2 | 100 | 1000 | 10 | 2 | potassium silicate | 10 | AB | 10 | 110 | 131 |
| Ex. 3 | A3 | 100 | 1000 | 8 | 3 | potassium silicate | 10 | graphite | 10 | 110 | 138 |
| Com. | B1 | (30) | (30) | 0.3 | 40 | — | — | AB | 10 | 100 | 100 |
| Ex. 1 | | | | | | | | | | | |
| Com. | B2 | (30) | (30) | 0.4 | 45 | potassium silicate | 10 | AB | 10 | 101 | 105 |
| Ex. 2 | | | | | | | | | | | |
| Com. | B3 | 100 | 1000 | 0.5 | 72 | CMC-Na + SBR | 10 | AB | 10 | 100 | 103 |
| Ex. 3 | | | | | | (1:1 by mass) | | | | | |
| Com. | B4 | 100 | 1000 | 0.4 | 77 | CMC-Na | 10 | AB | 10 | 100 | 103 |
| Ex. 4 | | | | | | | | | | | |

In the batteries A1 to A3 of Examples 1 to 3, as compared to in the batteries B1 to B4 of Comparative Examples 1 to 4, a high initial charge capacity was obtained, and the cycle characteristics were improved. In the batteries A2 and A3 of Examples 2 and 3, a further high initial charge capacity was obtained, and the cycle characteristics were further improved.

### INDUSTRIAL APPLICABILITY

The non-aqueous electrolyte secondary battery according to the present disclosure is useful as a main power supply for mobile communication equipment, portable electronic equipment, and other devices.

### REFERENCE SIGNS LIST

1 electrode group
2 positive electrode lead
3 negative electrode lead
4 battery case
5 sealing plate
6 negative electrode terminal
7 gasket
8 sealing stopper
10 negative electrode
11 negative electrode current collector
12 negative electrode mixture layer
12a first material mixture layer
12b second material mixture layer
13, 20 flaky Si particle
14 gap

1. A negative electrode for a non-aqueous electrolyte secondary battery, comprising:
a negative electrode current collector; and a negative electrode mixture layer supported on the negative electrode current collector, wherein
the negative electrode mixture layer includes a negative electrode active material capable of electrochemically absorbing and releasing lithium ions, a binder, and a conductive agent,
the negative electrode active material includes flaky silicon particles, and
the binder includes a silicate.

2. The negative electrode for a non-aqueous electrolyte secondary battery according to claim 1, wherein
the silicon particles have a thickness T of 30 nm or more and 250 nm or less, and
the silicon particles have a major axis diameter LD of 500 nm or more and 5000 nm or less.

3. The negative electrode for a non-aqueous electrolyte secondary battery according to claim 1, wherein at least part of a surface of the silicon particles is Covered with a silicon dioxide film.

4. The negative electrode for a non-aqueous electrolyte secondary battery according to claim 3, wherein a thickness of the silicon dioxide film is 2 inn or more and 50 nm or less.

5. The negative electrode for a non-aqueous electrolyte secondary battery according to claim 1, wherein in a dark-field image of the silicon particle taken using a transmission electron microscope, a ratio of an area of white portion(s) indicating crystals to an area of the silicon particle is 20% or less.

6. The negative electrode for a non-aqueous electrolyte secondary battery according to claim 1, wherein the silicon particles include at least one component selected from the group consisting of diamond, amorphous carbon, a zirconium oxide, an aluminum oxide, and an yttrium oxide.

7. The negative electrode for a non-aqueous electrolyte secondary battery according to claim 1, wherein the silicate includes at least one selected from a group consisting of potassium silicate, sodium silicate, and lithium silicate.

8. The negative electrode for a non-aqueous electrolyte secondary battery according to claim 1, wherein the conductive agent includes graphite.

9. The negative electrode for a non-aqueous electrolyte secondary battery according to claim 1, wherein a content of the silicon particles in the negative electrode mixture layer is 20 mass % or more 94 mass % or less with respect to a total mass of the negative electrode mixture layer.

10. The negative electrode for a non-aqueous electrolyte secondary battery according to claim 1, wherein a content of the silicate in the negative electrode mixture layer is 3 mass % or more and 20 mass % or less with respect to a total mass of the negative electrode mixture layer.

11. The negative electrode for a non-aqueous electrolyte secondary battery according to claim 1, wherein a content of the conductive agent in the negative electrode mixture layer is 3 mass % or more and 60 mass % or less with respect to a total mass of the negative electrode mixture layer.

12. The negative electrode for a non-aqueous electrolyte secondary battery according to claim 1, wherein
the negative electrode mixture layer has a first material mixture layer disposed on a surface of the negative electrode current collector, and a second material mixture layer covering a surface of the first material mixture layer,
the first material mixture layer includes the silicon particles, the silicate, and the conductive agent, and
the second material mixture layer includes the silicate and the conductive agent.

13. The negative electrode for a non-aqueous electrolyte secondary battery according to claim 1, wherein
the negative electrode current collector includes a metal foil, and
the metal foil has a surface roughness Ra of 0.5 μm or more and 5 μm or less.

14. A non-aqueous electrolyte secondary battery, comprising:
a positive electrode; a negative electrode; and a non-aqueous electrolyte, wherein
the negative electrode is the negative electrode of claim 1.

15. A method for producing a negative electrode for a nonaqueous electrolyte secondary battery, the method comprising:
a first step of preparing a first slurry containing an organic dispersion medium, and flaky silicon particles dispersed in the organic dispersion medium,
a second step of preparing a second slurry containing a silicate serving as a binder, a conductive agent, and water,
a third step of applying the first slurry onto a surface of a negative electrode current collector, to form a first applied film containing the silicon particles, and
a fourth step of applying the second shiny onto a Surface of the first applied film, to form a second applied film containing the silicate and the conductive agent.

16. The method for producing a negative electrode for a non-aqueous electrolyte secondary battery according to claim 15, wherein in the first step, the first slurry is obtained by dispersing a raw material silicon into the organic dispersion medium, followed by wet pulverization.

17. The method for producing a negative electrode for a non-aqueous electrolyte secondary battery according to claim 15, wherein in the fourth step, part of the second slurry is contained in the first applied film.

18. The method for producing a negative electrode for a non-aqueous electrolyte secondary battery according to claim 15, wherein the silicate includes an alkali metal salt.

19. The method for producing a negative electrode for a non-aqueous electrolyte secondary battery according to claim 15, wherein the conductive agent includes graphite.
